(19) United States
(12) Patent Application Publication
(10) Pub. No.: US 2024/0329404 A1
(43) Pub. Date: Oct. 3, 2024

(54) Method and Device for Operating a Display System With One or More Data Glasses in a Vehicle

(71) Applicant: Bayerische Motoren Werke Aktiengesellschaft, Muenchen (DE)

(72) Inventors: Tobias BAUERNFEIND, Muenchen (DE); Wolfgang HABERL, Muenchen (DE); Alan KEIM, Muenchen (DE); Manfred PAULI, Bruckberg (DE)

(21) Appl. No.: 18/619,302

(22) Filed: Mar. 28, 2024

(30) Foreign Application Priority Data
Mar. 30, 2023 (DE) 10 2023 108 110.1

(51) Int. Cl. G02B 27/01; G02B 27/00

(52) U.S. Cl. CPC G02B 27/0172; G02B 27/0093; G02B 2027/0138; G02B 2027/0178; G02B 2027/0183; G02B 2207/101

(57) ABSTRACT

A method assigns an absolute glasses pose indication acquired outside the glasses to one of multiple data glasses in a vehicle. The method includes: providing a respective set of a temporal profile of glasses pose indications, acquired outside the glasses, with respect to a vehicle coordinate system, for multiple data glasses, to at least one of the data glasses; in the at least one data glasses, ascertaining glasses movement information, wherein the glasses movement information indicates a temporal profile of incremental changes in the glasses pose of the at least one data glasses with respect to the vehicle coordinate system; performing a plausibility check between each of the sets of the profiles of the glasses pose indications acquired outside the glasses and the glasses movement information in order to obtain a respective error metric, wherein the error metric indicates the extent to which the set in question of the temporal profile of the glasses pose indications acquired outside the glasses matches the temporal profile of the glasses movement information; selecting one of the sets of the profiles of the glasses pose indications acquired outside the glasses in the at least one data glasses depending on the error metric; and signaling an indication in relation to the selected set of the profile of the glasses pose indications acquired outside the glasses.

### CROSS REFERENCE TO RELATED APPLICATION

This application claims priority under 35 U.S.C. § 119 from German Patent Application No. 10 2023 108 110.1, filed Mar. 30, 2023, the entire disclosure of which is herein expressly incorporated by reference.

### BACKGROUND AND SUMMARY

The invention relates to display systems in vehicles or other mobile devices in which one or more data glasses are operated using, or in conjunction with, an assistance system installed fixedly in the vehicle.

Augmented reality data glasses, also called head-mounted displays, which are able to depict an image on one or two display surfaces in the field of view of the wearer of the data glasses using a display device, are known. The display surfaces may correspond to reflection surfaces that direct images into the eye of the wearer of the data glasses. The viewing openings in the data glasses are transparent, such that it is also possible to perceive the real environment in the usual way using the display surfaces of the data glasses. The display surfaces are arranged in the viewing openings such that information to be displayed, such as for example text, symbols, graphics, video displays and the like, are able to be displayed in a manner overlaid on the perception of the environment.

The information may generally be depicted in a contact-like manner to the wearer of the data glasses, that is to say depicted such that the information to be displayed is overlaid on or oriented toward a specific assigned environment object in the real environment in the form of one or more display objects, or that the display object to be displayed is displayed in a specific alignment/orientation of the data glasses or the wearer thereof. Furthermore, the display object to be depicted in a contact-like manner may be depicted such that it appears to have the correct perspective with respect to the environment object in the real environment, that is to say creates the illusion that the environment object in the real environment has actually been supplemented by the additional feature of the visual display object.

However, in order to be able to depict the display object on the display surfaces of the data glasses accordingly in a contact-like manner, it is necessary to know the position of the environment object in the reference environment and the gaze direction of the user. The gaze direction of the user, when they are wearing the data glasses, is assigned fixedly to their glasses pose, that is to say the 3D position and the 3D orientation of the data glasses corresponding to six degrees of freedom (6 DoF).

The data glasses generally have a glasses motion sensor system and a computing device, for example in the form of a microprocessor. Using glasses movement information that is acquired at high frequency, in particular in the form of 3D acceleration information and/or 3D angular speed information, it is possible to track the current glasses pose of the data glasses in the vehicle passenger compartment by integrating the relative movement increments in order to obtain the glasses pose indication. In this case, the current glasses pose is first acquired with regard to the world environment.

When ascertaining the glasses pose indication by integrating the glasses movement information, an integration error generally occurs, which, without correction, leads to an increasing deviation between the glasses pose indication thus ascertained and the actual current glasses pose.

To ascertain the current glasses pose with respect to a vehicle coordinate system, movement information acquired in the vehicle, for example by the assistance system, may be transmitted to the data glasses such that it is possible to determine a glasses movement relative to or with respect to the vehicle by calculating a difference, which glasses movement is converted, using the integration method described above and in a manner known per se, into an absolute glasses pose with respect to the vehicle coordinate system.

In particular when using data glasses in a vehicle, it is possible to use a pose recognition unit of the assistance system to determine the glasses pose indication in relation to the glasses pose of the data glasses in the data glasses (outside-in-tracking method). This pose determination device is generally camera-based. For this purpose, a camera is provided in vehicles and is used to record a passenger compartment of the vehicle, and data glasses worn by vehicle occupants located therein are able to be detected. The pose determination device then evaluates the recorded camera image and is able to identify the data glasses and determine the poses of the identified data glasses using vision tracking methods that are known per se. In these so-called outside-in-tracking systems, an absolute glasses pose indication with respect to the vehicle that is ascertained outside the glasses is determined, that is to say a glasses pose indication with respect to a vehicle coordinate system tied to the vehicle.

By transmitting the known absolute glasses pose indications ascertained outside the glasses to the data glasses, sensor fusion methods make it possible to combine the absolute glasses pose indication of the data glasses (glasses pose indication ascertained outside the glasses) with glasses movement information acquired by an inertial sensor system provided in the data glasses in order to compensate for the integration error and to obtain a low-error current absolute glasses pose indication in real time. This then enables the contact-like depiction of display objects with respect to the coordinate system tied to the vehicle in the data glasses.

However, one difficulty is that, in the case of multiple data glasses located in the vehicle passenger compartment, of carrying out an assignment of the absolute glasses poses acquired in the pose determination device for each of the data glasses to the data glasses connected to the pose determination device via a respective communication channel. In other words, although the absolute glasses pose indications of the multiple data glasses are present in the pose determination device, the data glasses are connected to the pose determination device only via a communication channel, without the communication channel being able to be assigned to a specific position of data glasses or specific data glasses.

One object is therefore, at the start of operation of the display system, to carry out an assignment by way of which it is possible to assign certain absolute glasses pose indications ascertained outside the glasses in the position determination device in each case to a specific communication channel between the pose determination device and the data glasses in question. This then enables the targeted transmission of the absolute glasses pose indication ascertained outside the glasses to the respective data glasses.

This object is achieved by the method for operating a display system in a vehicle with a position determination device of an assistance system and multiple data glasses and also by the display system and an assistance system for such a display system, according to the independent claims. Further embodiments are specified in the dependent claims.

According to a first aspect, provision is made for a method for assigning an absolute glasses pose indication acquired outside the glasses to one of multiple data glasses in a vehicle, having the following steps:
providing a respective set of a temporal profile of glasses pose indications, acquired outside the glasses, with respect to a vehicle coordinate system, for multiple data glasses, to at least one of the data glasses;
in the at least one data glasses, ascertaining glasses movement information, wherein the glasses movement information indicates a temporal profile of incremental changes in the glasses pose of the at least one data glasses with respect to the vehicle coordinate system;
in the at least one data glasses, performing a plausibility check between each of the sets of the profiles of the glasses pose indications acquired outside the glasses and the glasses movement information in order to obtain a respective error metric, wherein the error metric indicates the extent to which the set in question of the temporal profile of the glasses pose indications acquired outside the glasses matches the temporal profile of the glasses movement information;
in the at least one data glasses, selecting one of the sets of the profiles of the glasses pose indications acquired outside the glasses in the at least one data glasses depending on the error metric; and
using the at least one data glasses to signal an indication in relation to the selected set of the profile of the glasses pose indications acquired outside the glasses to an assistance system outside the glasses.

The data glasses have a glasses motion sensor system (IMU: Inertial Measurement Unit) for ascertaining glasses movement information. The glasses movement information is available at high frequency and represents relative information regarding the movement of the data glasses in space, that is to say in the form of an angular speed and/or angular acceleration with respect to the one or more directions in space under consideration. Using integration methods, the glasses movement information is able to determine a movement trajectory of the data glasses with regard to their position and orientation (with respect to an environment coordinate system), that is to say their glasses pose.

The glasses movement information, which indicates the temporal profile of incremental changes in the glasses pose of the at least one data glasses, may be ascertained based on vehicle movement information indicating a temporal profile of incremental changes in the pose of the vehicle in the environment.

For this purpose, the vehicle movement information from a corresponding vehicle motion sensor system may additionally be transmitted to the data glasses and used to eliminate the influence of the vehicle movement in the surroundings, such that the glasses pose indication with respect to the vehicle coordinate system may be obtained using the integration method. The vehicle movement information is available at high frequency and represents relative information regarding the movement of the data glasses in space, that is to say in the form of an angular speed and/or angular acceleration with respect to the one or more directions in space under consideration.

Due to the integration error that occurs, during normal operation, an absolute glasses pose indication ascertained outside the glasses via external methods is additionally used to reduce the pose error of the glasses pose indication, ascertained in the data glasses using integration methods, using suitable sensor fusion methods and thus always provide a corrected accurate glasses pose indication in the data glasses.

A camera is often used to determine the absolute glasses pose indication ascertained outside the glasses, which camera is directed into the passenger compartment and recognizes data glasses depicted in the camera image using pattern recognition methods, and is thus able to determine the absolute glasses poses thereof in the vehicle passenger compartment (using a so-called vision tracking method).

Provision may accordingly be made for the provision of the temporal profile of glasses pose indications ascertained outside the glasses for multiple data glasses to comprise capturing a camera image of a vehicle passenger compartment and identifying data glasses in the camera image using a vision tracking method. The data glasses thus identified in the camera image may be analyzed using the vision tracking method, and glasses pose indications may be determined for each of the identified data glasses. Evaluating temporally successive camera images makes it possible to determine sets of temporal profiles of the glasses pose indications in relation to the glasses poses of the respective identified data glasses with respect to a vehicle coordinate system.

Using sensor data fusion methods, the absolute glasses pose indication ascertained outside the glasses, which is transmitted to the data glasses via a communication channel, and the glasses pose indication ascertained inside the glasses using integration methods are combined, and the integration errors resulting from the integration method applied to the glasses movement information are thus significantly reduced. The communication channel may for example, in the case of a Wi-Fi connection between the assistance system and the data glasses, be determined by an IP address of the respective data glasses, such that it is possible to address specific data glasses by addressing with the corresponding IP address. The IP address is then used, in the case of multiple data glasses, to identify a specific one of the data glasses.

In principle, the above method is based on a display system having an assistance system fixed in the vehicle, which assistance system has a camera directed into the vehicle passenger compartment and comprises a pose determination device that evaluates the camera image recorded by the camera in order to identify data glasses therein and to ascertain their respective absolute glasses pose indications with respect to a coordinate system tied to the vehicle. Thus, if data glasses are recognized, the absolute glasses pose indication with respect to the coordinate system tied to the vehicle may be timestamped and transmitted to the connected data glasses via the communication channel.

In the case of multiple data glasses in the passenger compartment of the vehicle, the problem arises that multiple data glasses are identified in the camera image and multiple absolute glasses pose indications outside the glasses are accordingly ascertained using the vision tracking method. Due to the position of the absolute glasses pose indication, the data glasses thus recognized are able to be assigned uniquely to seats in the vehicle, such that the data glasses are uniquely identified in the assistance system. However, the data glasses are connected to the assistance system only via a communication channel that is independent of position, and it is thus possible only to set up communication connections to the multiple data glasses, without the assistance system knowing which of the communication channels leads to which of the data glasses.

It is thus necessary, at the start of commissioning, to establish, using an initialization method, which of the absolute glasses pose indications determined outside the glasses should be transmitted to which of the data glasses, in order to provide an improved glasses pose indication there through sensor fusion. For this purpose, the above method proposes, in an initialization phase, to transmit all of the absolute glasses pose indications acquired by the pose determination device to each of the data glasses. For this purpose, for each of the data glasses, an assigned set of a temporal profile is transmitted to multiple temporally consecutive glasses pose indications.

In the data glasses, a method is carried out in which each received set of the timestamped absolute glasses pose indications outside the glasses is plausibility-checked with regard to a temporal profile of the glasses pose indication present derived inside the glasses from the glasses movement information.

The plausibility check makes it possible, for an observation period, to determine an error metric of a profile error between the respective set of the profile of the glasses pose indications acquired outside the glasses and the temporal profile of the glasses pose indications ascertained inside the glasses from the glasses movement information using the integration method. Due to the application of the integration method to the glasses movement information, in each case based on a known absolute glasses pose indication ascertained outside the glasses at a specific time, an error metric is obtained for each of the sets when ascertaining the movement trajectories.

The error metric may be determined or accumulated over a specific period, for example by integration. That set of the profile of the glasses pose indications acquired outside the glasses for which the smallest error, that is to say the smallest value of the error metric, is obtained defines the data glasses as those data glasses to which the set of underlying glasses pose indications acquired outside the glasses is able to be assigned.

Each of the data glasses then communicates or signals information (for example the IP address assigned to the data glasses) to the assistance system, in each case via the corresponding communication channel, indicating that it is possible, via the corresponding communication channel, to address those data glasses that are assigned to the identified set of the absolute glasses pose indications outside the glasses. By way of example, an indication is communicated to the assistance system, via the communication channel of the data glasses in question, as to which of the previously transmitted sets of the temporal profiles of the glasses pose indications determined outside the glasses is assigned to the data glasses in question.

The initialization phase is then ended and, as a result, only those absolute glasses pose indications ascertained outside the glasses that are assigned to the corresponding data glasses are transmitted to each of the data glasses. In the case of multiple identified data glasses, the amount of data to be transmitted may thereby be significantly reduced.

For the plausibility check, that is to say ascertaining the match or the error between the temporal profile of the glasses pose indication ascertained inside the glasses depending on the glasses movement information and the sets of absolute glasses pose indications outside the glasses, a Kalman filter may be used, for example. The innovation in the correction step may be used to establish the set of absolute glasses pose indications outside the glasses for which the calculated Kalman filter has the smallest error. Information in relation to the data glasses assigned to the resulting set of absolute glasses pose indications is then transmitted to the assistance system. The innovation indicates how close the value predicted by the glasses pose indications ascertained inside the glasses is to an absolute glasses pose indication outside the glasses at a specific time.

As an alternative, for each set, the orientations may be derived as a function of time from the absolute glasses pose indications ascertained outside the glasses, so as to give a temporal profile of the angular speed. This temporal profile of the angular speed may then be compared with the simultaneously acquired profile of the angular speed from the glasses movement information, which is in particular corrected by the vehicle movement information. For the time interval under consideration, an error metric may then be calculated by comparing the profiles, for example by time-integrating the difference between the profiles, wherein the smallest error metric indicates the degree of matching between the set of the profile of the absolute glasses pose indication ascertained outside the glasses and the profile of the glasses movement information.

According to a further aspect, provision is made for a method for operating an assistance system, fixed in a vehicle, of a display system with multiple data glasses, having the following steps:
providing a respective set of a temporal profile of glasses pose indications, acquired outside the glasses, with respect to a vehicle coordinate system, for multiple data glasses, to at least one of the data glasses;
receiving an indication in relation to a selected set of the profile of the glasses pose indications acquired outside the glasses via a specific communication channel; and
after signaling the indication in relation to the selected set of the profile of the glasses pose indications acquired outside the glasses, transmitting only the glasses pose indications that are assigned to the data glasses determined by the selected set to the corresponding data glasses via the specific communication channel.

According to a further aspect, provision is made for a display system having an assistance system and multiple data glasses, comprising:
the assistance system, which is designed to provide a respective set of a temporal profile of glasses pose indications, acquired outside the glasses, with respect to a vehicle coordinate system, for multiple data glasses, to at least one of the data glasses; and
at least one of the data glasses, which is designed
   to ascertain a temporal profile of glasses movement information, wherein the glasses movement information indicates a temporal profile of incremental changes in the glasses pose of the at least one data glasses with respect to the vehicle coordinate system;
   to perform a plausibility check between each of the sets of the profiles of the glasses pose indications acquired outside the glasses and the glasses movement information in order to obtain a respective error metric, wherein the error metric indicates the extent to which the set in question of the temporal profile of the glasses pose indications acquired outside the glasses matches the temporal profile of the glasses movement information;
   to select one of the sets of the profiles of the glasses pose indications acquired outside the glasses in the at least one data glasses depending on the error metric; and
   to signal an indication in relation to the selected set of the profile of the glasses pose indications acquired outside the glasses to the assistance system.

According to a further aspect, provision is made for an assistance system, wherein the assistance system is designed:
to provide sets of a temporal profile of glasses pose indications, acquired outside the glasses, with respect to a vehicle coordinate system, for multiple data glasses, to at least one of the data glasses; and
to receive an indication in relation to a selected set of the profile of the glasses pose indications acquired outside the glasses via a specific communication channel, and
after the signaling, to transmit only the glasses pose indications that are assigned to the data glasses determined by the selected set to the corresponding data glasses via the specific communication channel.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of a display system having an assistance system and multiple data glasses in a vehicle, in a plan view of a vehicle;

FIG. 2 is a schematic illustration of a display system for depicting the communication between the assistance system and the data glasses; and

FIG. 3 is a flowchart for illustrating a method for operating the display system in the vehicle.

### DETAILED DESCRIPTION OF THE DRAWINGS

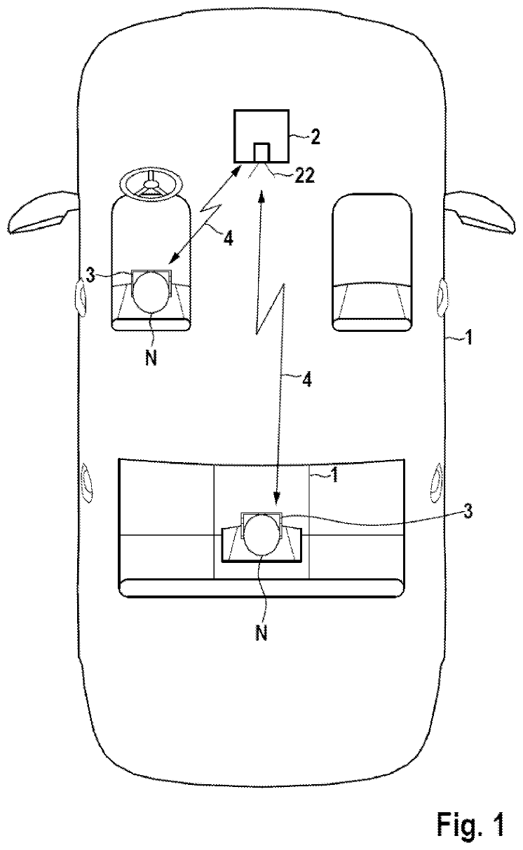

FIG. 1 schematically shows a plan view of a vehicle system having a vehicle 1, in which multiple vehicle occupants N are each wearing data glasses 3. The data glasses 3 are connected, either in wired form or wirelessly, to a pose recognition system 2, which is fixed in the vehicle, via a respective communication connection 4, which constitutes a corresponding communication channel.

The communication connection 4 is designed as a data transmission channel, for example in the form of a wireless communication connection or a wired communication connection. The communication connection 4 is capable of transmitting any kind of data and information between the assistance system 2 and the data glasses 3, for example based on a packet-bound data transmission. By way of example, the communication connection 4 may be based on Wi-Fi, Bluetooth, Bluetooth Low Energy or a comparable standardized radio protocol. By way of example, the communication channel of the communication connection 4 may be determined by an IP address.

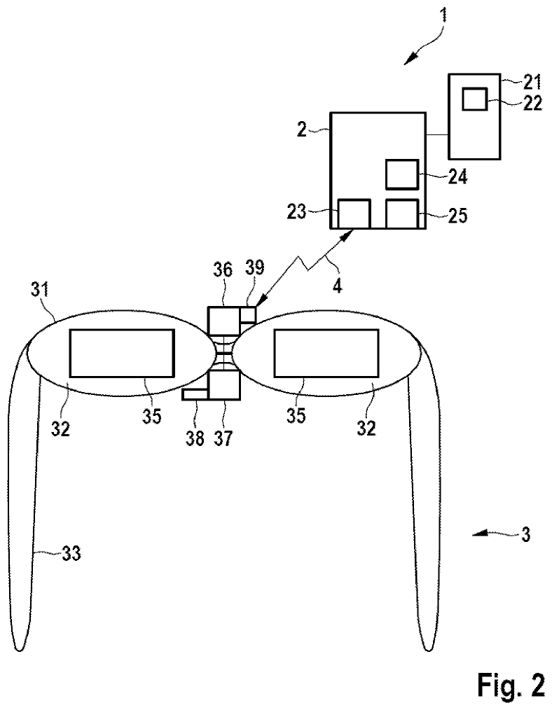

FIG. 2 shows a more schematic illustration of the vehicle system.

The assistance system 2 may be part of a vehicle assistance system and in particular be provided statically in the vehicle 1. The assistance system 2 may be equipped with a communication unit 23 that enables the communication connection 4 between the respective data glasses 3 and the assistance system 2.

The assistance system 2 may furthermore be connected to the camera system, which has a plurality of cameras 22 directed into the passenger compartment of the vehicle. The camera system is able to capture the vehicle occupants N as a camera image. The one or more cameras 22 may comprise for example an RGB camera, an IR camera, a fisheye camera, a dynamic vision sensor and the like.

The assistance system 2 may have a control unit 24 to evaluate the camera image using a pattern recognition method (vision tracking method) and to ascertain therefrom an absolute glasses pose indication of the one or more data glasses 3 in the vehicle using vision tracking methods that are known per se.

Furthermore, the assistance system 2 comprises a vehicle motion sensor system (IMU sensor system) 25, which may be designed for example in the form of a 6-DoF inertial sensor. This provides movement indications in relation to a movement of the vehicle 1 in the form of translational accelerations or angular accelerations or angular speeds.

The data glasses 3 comprise two transparent lenses 32 that are enclosed in a frame 31 in a manner known per se. The frame 31 is provided, by way of example, with glasses temples 33, so that the data glasses 3 are able to be worn on the head of a user.

One or both lenses 32 (glasses lenses) are furthermore provided with a transparent display surface 35, through which a display image for depicting virtual display objects is able to be projected in the eye of the wearer of the data glasses 3 by a suitable device, such as for example a display device 36 arranged on the frame 31. The display device 36 may have a microprocessor or a comparable computing unit and a display unit, such as for example a projection device or the like. The display unit may be designed to direct the electronically generated display image onto the display surface 35 and to image/depict it there.

Due to the transparent design of the display surface 35, the electronically generated image is able to overlay the real environment able to be perceived through by the display surface 35. The display device 36 may be used to depict a virtual display object, such as for example a text, a symbol, video information, a graphic or the like, on one or both display surfaces 35.

The data glasses 3 may be worn on the head of the user like a typical visual aid, wherein the data glasses 3 may rest on the nose of the user by way of the frame 31 and the temples 33 may lie laterally against the head of the user. The user then gazes straight ahead through the transparent display surfaces 35 of the lenses 32, such that the gaze direction of the user, which is specified by an eye position and an optical gaze axis (eye axis), has a fixed reference with respect to the orientation of the data glasses 3. This reference depends individually on the wearer of the data glasses 3 and is indicated by calibration information.

For the display of display objects, corresponding object information in the form of object data is transmitted from the assistance system 2 to the data glasses 3 or already provided in the data glasses 3. The object data in this case indicate the type of display object, such as for example a text object, an icon or another identifier of a display area, the viewing angle area or the viewing angle areas in which the display object should be displayed on the display surface 35 and the object position in the environment of the data glasses 3. The object position may be indicated with respect to an environment coordinate system tied to the world or a vehicle coordinate system tied to the vehicle.

Provision may be made for a glasses motion sensor system 38 (IMU sensor system, inertial sensor system) that is designed for example in the form of a 6-DoF inertial sensor. This provides movement indications in relation to a movement of the data glasses 3 in the form of translational accelerations and angular accelerations or angular speeds, which may be converted, in particular by a respective (including double) integration, into a change in position and orientation, that is to say a differential glasses pose, such that it is possible to update an indication in relation to a glasses pose at high frequency by applying a time integration method.

The changes in position and orientation (differential glasses pose) ascertained via the glasses motion sensor system 38 may be used, in a manner known per se, to determine a glasses pose indication, tied to the world, for a current glasses pose of the data glasses 3. To ascertain a glasses pose indication tied to the vehicle, it is possible to calculate a difference from the vehicle movement information, using which it is possible to calculate the movement of the data glasses 3 in the vehicle, that is to say with respect to the vehicle coordinate system.

Using a control unit 37, for example, it is possible to receive object information via a communication device 39 from the assistance system 2 or provide and process said object information in some other way, such that it is displayed in a contact-like manner depending on the glasses pose with respect to the environment coordinate system in the respective viewing angle area in which the user of the data glasses 3 looks and in which environment objects are able to be perceived. In other words, the display object indicated by the object information is displayed on the display surface 35 if its environment position is in the viewing angle area.

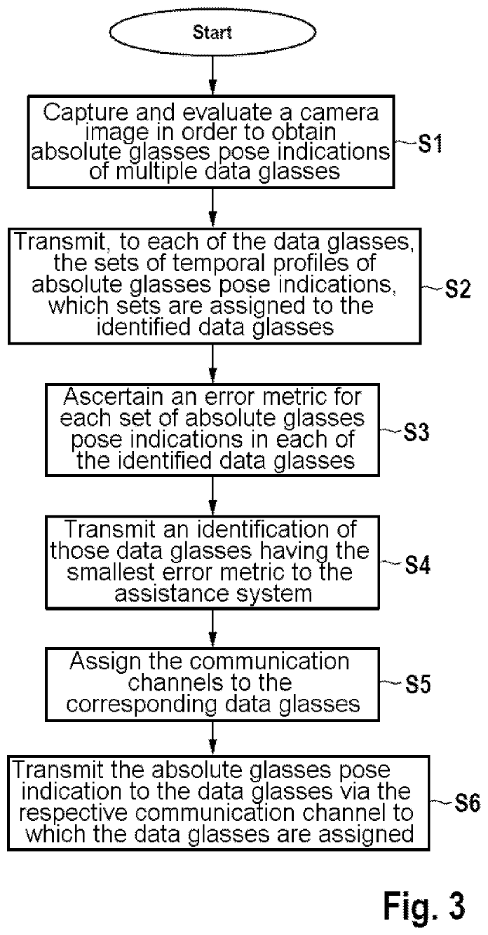

FIG. 3 shows a flowchart for illustrating a method as is carried out in the display system.

In step S1, a camera image is first captured and evaluated in the assistance system using a vision tracking method. The vision tracking method makes it possible to identify data glasses in the vehicle passenger compartment and to determine their respective absolute glasses pose indications. The vision tracking method in this respect provides a temporal profile of the absolute glasses pose indication for each of the identified data glasses.

For the assignment of a communication channel between the assistance system 2 and the respective data glasses 3 to one of the identified data glasses, in step S2, a corresponding set of a respective temporal profile of the absolute glasses pose indications ascertained outside the glasses is then transmitted to each of the data glasses 3 for each of the data glasses 3 identified in the camera image.

In a subsequent step S3, each of the data glasses 3 launches an algorithm in which an error metric is ascertained for each of the sets of the profiles of the absolute glasses pose indications ascertained outside the glasses.

In this case, the absolute glasses pose indications, ascertained outside the glasses, of a set and the glasses pose indications acquired inside the glasses in the respective data glasses 3 depending on the glasses movement information are plausibility-checked or compared with one another. This gives an error metric for each set that indicates the extent to which the temporal profile of the absolute glasses pose indications, ascertained outside the glasses, of the set in question deviates from the profile of the glasses pose indication acquired inside the glasses depending on the glasses movement information.

The temporal profiles of the absolute glasses pose indications acquired outside the glasses are assigned uniquely to specific data glasses 3 by the position contained in the glasses pose indication, since only one data glasses 3 may be present in the vehicle passenger compartment per seat. Thus, data glasses 3 in the vehicle passenger compartment are determined or identified by the spatial area in which they are located.

In step S4, each of the data glasses 3 that is connected to the assistance system 2 transmits an indication about the set of absolute glasses pose indications acquired outside the glasses and for which the smallest error metric has been determined back to the assistance system 2.

In step S5, the assistance system 2 may then, depending on the communication channel via which the indication of the set was received, assign the communication channel that identifies the specific data glasses 3 to a position in the vehicle passenger compartment, such that, as a result, in step S6, the identified data glasses 3 are able to be addressed via the corresponding communication channel. The absolute glasses pose indications ascertained outside the glasses that are acquired as a result may then be transmitted in a targeted manner only to the relevant data glasses for sensor data fusion.

The comparison between the sets of the temporal profiles of the absolute glasses pose indications ascertained outside the glasses and the temporal profile of the glasses movement information may be performed using Kalman filtering. The innovation in the correction step of the Kalman filter may be used as an error metric to select the set of the temporal profiles of the absolute glasses pose indications ascertained outside the glasses that results in the smallest error.

In an alternative embodiment, the temporal profiles of the absolute glasses pose indications of each set may be derived as a function of time in order to obtain a corresponding profile of the angular speeds (in space). The profile of the corresponding angular speeds may then be compared with the profile of the angular speeds resulting from the glasses movement information corrected by the vehicle movement information. In each case, it is possible to ascertain an error metric from the deviations between the sets of the angular speeds ascertained from the absolute glasses pose indications and the corresponding angular speeds based on the glasses movement information. The error metric, which indicates the smallest deviation between the profiles, determines the corresponding set of absolute glasses pose indications and thereby the identification or position of the data glasses 3 in the vehicle passenger compartment, which is then transmitted back to the assistance system 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Vehicle
2 Assistance system
3 Data glasses
4 Communication connection
22 Camera
23 Communication unit
24 Control unit
25 Vehicle motion sensor system
31 Frame
32 Lenses
33 Glasses temples
35 Display surface
36 Display device
37 Control unit
38 Glasses motion sensor system
39 Communication device

What is claimed is:

1. A method for assigning an absolute glasses pose indication acquired outside the glasses to one of multiple data glasses in a vehicle, the method comprising the steps of:
providing a respective set of a temporal profile of glasses pose indications, acquired outside the glasses, with respect to a vehicle coordinate system, for the multiple data glasses, to at least one of the data glasses;
in the at least one data glasses, ascertaining glasses movement information, wherein the glasses movement information indicates a temporal profile of incremental changes in the glasses pose of the at least one data glasses with respect to the vehicle coordinate system;
in the at least one data glasses, performing a plausibility check between each of the sets of the profiles of the glasses pose indications acquired outside the glasses and the glasses movement information in order to obtain a respective error metric, wherein the error metric indicates the extent to which the set in question of the temporal profile of the glasses pose indications acquired outside the glasses matches the temporal profile of the glasses movement information;
in the at least one data glasses, selecting one of the sets of the profiles of the glasses pose indications acquired outside the glasses in the at least one data glasses depending on the error metric; and
using the at least one data glasses to signal an indication in relation to the selected set of the profile of the glasses pose indications acquired outside the glasses, to an assistance system outside the glasses.

2. The method according to claim 1, wherein the provision of the temporal profile of glasses pose indications acquired outside the glasses for the multiple data glasses comprises:
capturing a camera image of a vehicle passenger compartment,
identifying data glasses in the camera image using a vision tracking method, and
determining the sets of the temporal profiles of the glasses pose indications in relation to their glasses poses with respect to a vehicle coordinate system.

3. The method according to claim 1, wherein
the glasses movement information is ascertained based on vehicle movement information that indicates a temporal profile of incremental changes in the pose of the vehicle in the environment.

4. The method according to claim 1, wherein
a plausibility check is performed between the profile of the glasses pose indications acquired outside the glasses for the multiple data glasses in order to obtain a respective error metric by determining the error metric between the temporal profile of the glasses pose indication ascertained inside the glasses depending on the glasses movement information and the sets of the absolute glasses pose indications ascertained outside the glasses using a Kalman filter depending on an innovation in the correction step.

5. The method according to claim 1, wherein
a plausibility check is performed between the profile of the glasses pose indications acquired outside the glasses for the multiple data glasses in order to obtain a respective error metric by determining a profile of the angular speed from the profile of the absolute glasses pose indications ascertained outside the glasses by time derivation, wherein the error metric is calculated by comparing the profile of an angular speed of the glasses movement information and the profile of the angular speed as determined from the glasses pose indication ascertained outside the glasses.

6. The method according to claim 1, wherein
after signaling the indication in relation to the selected set of the profile of the glasses pose indications acquired outside the glasses to the assistance system outside the glasses, the assistance system transmits only the glasses pose indications assigned to the data glasses determined by the selected set to the corresponding data glasses.

7. A method for operating an assistance system, fixed in a vehicle, of a display system with multiple data glasses, the method comprising the steps of:
providing a respective set of a temporal profile of glasses pose indications, acquired outside the glasses, with respect to a vehicle coordinate system, for the multiple data glasses, to at least one of the data glasses;
receiving an indication in relation to a selected set of the profile of the glasses pose indications acquired outside the glasses via a specific communication channel; and
after signaling the indication in relation to the selected set of the profile of the glasses pose indications acquired outside the glasses, transmitting only the glasses pose indications that are assigned to the data glasses determined by the selected set to the corresponding data glasses via the specific communication channel.

8. A display system having multiple data glasses, comprising:
an assistance system, which is designed to provide a respective set of a temporal profile of glasses pose indications, acquired outside the glasses, with respect to a vehicle coordinate system, for the multiple data glasses, to at least one of the data glasses; and
the at least one of the data glasses, which is designed to:
ascertain a temporal profile of glasses movement information, wherein the glasses movement information indicates a temporal profile of incremental changes in the glasses pose of the at least one data glasses with respect to the vehicle coordinate system;
perform a plausibility check between each of the sets of the profiles of the glasses pose indications acquired outside the glasses and the glasses movement information in order to obtain a respective error metric, wherein the error metric indicates the extent to which the set in question of the temporal profile of the glasses pose indications acquired outside the glasses matches the temporal profile of the glasses movement information;
select one of the sets of the profiles of the glasses pose indications acquired outside the glasses in the at least one data glasses depending on the error metric; and
signal an indication in relation to the selected set of the profile of the glasses pose indications acquired outside the glasses to the assistance system.

9. An assistance system for a display system, wherein the assistance system is designed to:
provide sets of a temporal profile of glasses pose indications, acquired outside the glasses, with respect to a vehicle coordinate system, for multiple data glasses, to at least one of the data glasses; and
receive an indication in relation to a selected set of the profile of the glasses pose indications acquired outside the glasses via a specific communication channel, and
after the signaling, transmit only the glasses pose indications that are assigned to the data glasses determined by the selected set to the corresponding data glasses via the specific communication channel.
